(19) United States
(12) Patent Application Publication
(10) Pub. No.: US 2013/0335028 A1
(43) Pub. Date: Dec. 19, 2013

(54) BATTERY PACK AND METHOD OF CONTROLLING THE SAME

(71) Applicant: SAMSUNG SDI CO; LTD., Gyeonggi-do (KR)

(72) Inventor: Hyo-Joon Choi, Gyeonggi-do (KR)

(73) Assignee: Samsung SDI Co; Ltd., Gyeonggi-do (KR)

(21) Appl. No.: 13/664,095

(22) Filed: Oct. 30, 2012

(30) Foreign Application Priority Data
Jun. 19, 2012 (KR) 10-2012-0065611

(51) Int. Cl. H02J 7/00

(52) U.S. Cl. 320/126

(57) ABSTRACT

A battery pack is disclosed. The battery pack includes a first battery cell group having a plurality of battery cells, and a second battery cell group having a plurality of battery cells. The battery pack also includes a first impedance unit serially connected to the first battery cell group, a second impedance unit serially connected to the second battery cell group, and a battery management unit respectively determining a degree of deviation of the first battery cell group and the second battery cell group to adjust impedances of the first impedance unit and the second impedance unit. Accordingly, a decrease in performance due to deviation difference between batteries may be prevented.

### CROSS-REFERENCE TO RELATED APPLICATIONS

This application claims the benefit of Korean Patent Application No. 10-2012-0065611, filed on Jun. 19, 2012, in the Korean Intellectual Property Office, the disclosure of which is incorporated herein in its entirety by reference.

### BACKGROUND

1. Field

The disclosed technology relates to battery packs and methods of controlling the same.

2. Description of the Related Technology

Since mobile devices such as mobile phones, digital cameras, laptop computers or the like have become more popular, batteries for supplying power to such mobile devices have been actively developed. Also, large capacity battery systems for use in electric vehicles, uninterruptable power supplies (UPS), and energy storage systems or the like have also been actively developed.

A battery is included in a battery pack, which also includes a protection circuit for controlling charging and discharging of the battery. As defects may occur in the battery of the battery pack during charging or discharging, the protection circuit includes various devices to stably control charging and discharging of the battery.

### SUMMARY OF CERTAIN INVENTIVE ASPECTS

One inventive aspect is a battery pack including a first battery cell group having a plurality of battery cells, and a second battery cell group having a plurality of battery cells. The battery pack also includes a first impedance unit serially connected to the first battery cell group, a second impedance unit serially connected to the second battery cell group, and a battery management unit respectively configured to determine a degree of deviation of the first battery cell group and the second battery cell group to adjust impedances of the first impedance unit and the second impedance unit.

Another inventive aspect is a method of controlling a battery pack including a first battery cell group, a second battery cell group, a first impedance unit that is serially connected to the first battery cell group, a second impedance unit that is serially connected to the second battery cell group, and a battery management unit configured to adjust impedances of the first impedance unit and the second impedance unit. The method includes respectively determining a degree of deviation of the first battery cell group and the second battery cell group, and determining a charging state of the first battery cell group as a result of the degree of deviation of the first battery cell group being greater than the degree of deviation of the second battery cell. The method also includes comparing a charging state of the first battery cell with a reference value, and adjusting impedances of the first impedance unit and the second impedance unit according to a result of the comparing during charging or discharging of the battery pack.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating a battery pack according to an embodiment;

FIG. 2 is a block diagram illustrating a battery management unit according to an embodiment;

FIG. 3 is a flowchart illustrating a method of controlling a battery pack according to an embodiment;

FIG. 4 is a flowchart illustrating a method of controlling a battery pack according to another embodiment;

FIG. 5 is a flowchart illustrating a method of controlling a battery pack according to another embodiment;

FIG. 6 is a block diagram illustrating a battery pack according to another embodiment;

FIG. 7 is a block diagram illustrating an energy storage system including a battery pack is applied, according to an embodiment; and

FIG. 8 is a block diagram illustrating a battery system according to an embodiment.

### BRIEF DESCRIPTION OF THE DRAWINGS

Reference will now be made in detail to embodiments, examples of which are illustrated in the accompanying drawings, wherein like reference numerals generally refer to the like elements throughout. The presented embodiments may be implemented in different forms and should not be construed as being limited to the specific descriptions set forth herein. Accordingly, the embodiments are merely described below, by referring to the figures, to explain certain aspects of the present description. As used herein, the term “and/or” includes any and all combinations of one or more of the associated listed items.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes are encompassed in the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In certain instances, components that are the same or are in correspondence are rendered the same reference numeral regardless of the figure number, and redundant explanations may be omitted.

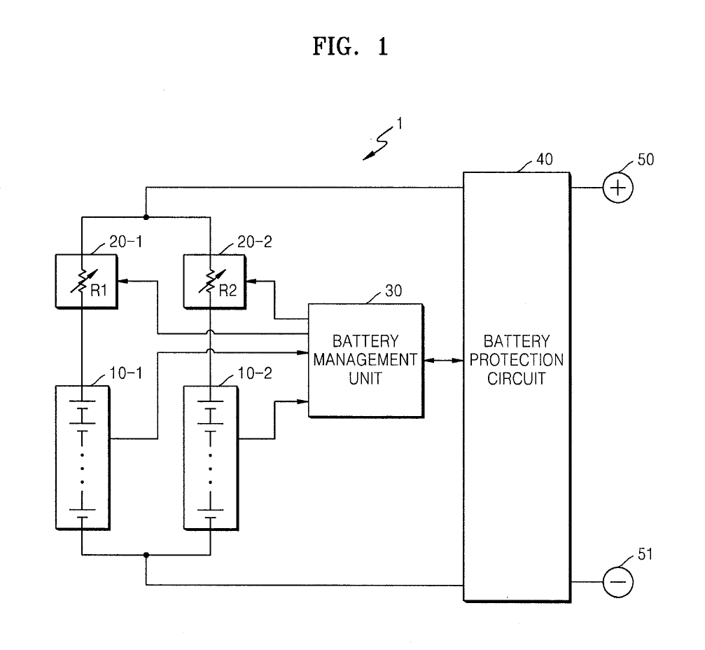

FIG. 1 is a block diagram illustrating a battery pack 1 according to an embodiment of the present invention. Referring to FIG. 1, the battery pack 1 includes a first battery cell group 10-1, a second battery cell group 10-2, a first impedance unit 20-1, a second impedance unit 20-2, a battery management unit 30, a battery protection circuit 40, a positive electrode terminal 50, and a negative electrode terminal 51.

The first battery cell group 10-1 and the second battery cell group 10-2 store power supplied from the outside, and supply the stored power to a load. Each of the first battery cell group 10-1 and the second battery cell group 10-2 may include a plurality of battery cells as rechargeable secondary batteries. Examples of battery cells used in the first battery cell group 10-1 and the second battery cell group 10-2 include nickel-cadmium batteries, lead storage batteries, nickel metal hydride (NiMH) batteries, lithium ion batteries, and lithium polymer batteries.

The first impedance unit 20-1 is serially connected to the first battery cell group 10-1. For example, the first impedance unit 20-1 may include a variable resistor R1. The magnitude of the impedance of the first impedance unit 20-1 is adjusted by the battery management unit 30.

The second impedance unit 20-2 is serially connected to the second battery cell group 10-2. For example, the second impedance unit 20-2 may include a variable resistor R2. The magnitude of the impedance of the second impedance unit 20-2 is adjusted by the battery management unit 30.

The battery management unit 30 controls the overall operation of the battery pack 1. The battery management unit 30 may monitor a voltage and temperature of battery cells included in the first battery cell group 10-1 and the second battery cell group 10-2 to receive voltage data and temperature data. Also, the battery management unit 30 may receive current data by monitoring a current flowing through a high current path. Also, the battery management unit 30 may determine a degree of deviation of the first battery cell group 10-1 and the second battery cell group 10-2, and may adjust impedance of the first impedance unit 20-1 and the second impedance unit 20-2 based on a result of the determination.

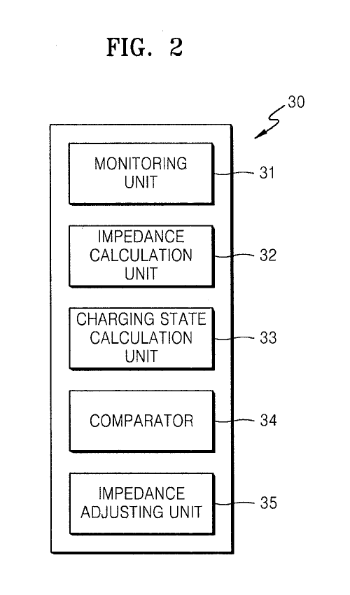

FIG. 2 is a block diagram illustrating the battery management unit 30 according to an embodiment. The battery management unit 30 includes a monitoring unit 31, an impedance calculation unit 32, a charging status calculation unit 33, a comparator 34, and an impedance adjusting unit 35.

The monitoring unit 31 monitors states of various parameters of the first battery cell group 10-1 and the second battery cell group 10-2. For example, the monitoring unit 31 may monitor a voltage and a temperature of the first and the second battery cell groups 10-1 and 10-2 and each battery cell included in the first and the second battery cell groups 10-1 and 10-2. Also, the monitoring unit 31 may monitor a current flowing through a high current path or a current flowing to the first battery cell group 10-1 and the second battery cell group 10-2.

The impedance calculation unit 32 may use voltage, temperature, and current data obtained by the monitoring unit 31 to calculate an inner impedance of the first battery cell group 10-1 and the second battery cell group 10-2. The calculated inner impedance may be used in determining a degree of deviation of the first battery cell group 10-1 and the second battery cell group 10-2. That is, it may be determined that the deviation is higher as the magnitude of the calculated inner impedance is greater. In contrast, it may be determined that the deviation is less as the magnitude of the inner impedance is less. The determined deviation could be the result of a degradation over time from cycling of charging and discharging, for example.

The charging state calculation unit 33 calculates a charging state of the first battery cell group 10-1 and the second battery cell group 10-2 by using voltage, temperature, and current data obtained by the monitoring unit 31. The calculated charging state may be used as a basis for adjusting the impedance of the first impedance unit 20-1 and the second impedance unit 20-2.

The comparator 34 compares magnitudes of the inner impedance of the first battery cell group 10-1 and the second battery cell group 10-2 that are calculated by the impedance calculation unit 32. Battery cell group with a greater inner impedance may be a reference for adjusting the impedance of the first impedance unit 20-1 and the second impedance unit 20-2. That is, a battery cell group with a large degree of deviation may be used as a reference for adjusting the impedance of the first impedance unit 20-1 and the second impedance unit 20-2.

Also, the comparator 34 compares a charging state of a battery cell group determined as having a large inner impedance (large degree of deviation) from among the calculated charging states by the charging state calculation unit 33 with a reference value. For example, the reference value may be 70% of full charging. Also, the reference value may vary according to types of battery cells or applications to which battery cell groups are applied. For example, when applied to an energy storage system, a reference value may be 80% of full charging.

The impedance adjusting unit 35 adjusts the impedance of the first impedance unit 20-1 and the second impedance unit 20-2 according to a comparison result of charging states by using the comparator 34. Here, the impedance of the impedance adjusting unit 35 may be adjusted in the following manner.

First, for convenience of description, it is assumed that the comparator 34 determines that the inner impedance of the first battery cell group 10-1 is greater than the inner impedance of the second battery cell group 10-2. That is, a degree of deviation of the first battery cell group 10-1 is greater than that of the second battery cell group 10-2.

When the battery pack 1 is in a charging state, the comparator 34 compares a charging state of the first battery cell group 10-1 with a reference value. If a charging state of the first battery cell group 10-1 is equal to or less than the reference value, the impedance adjusting unit 35 determines that a current state of the first battery cell group 10-1 is a low-capacity state. In a low-capacity state, the same current may preferably flow through the first battery cell group 10-1 and the second battery cell group 10-2 because the same charging amount per unit time may be maintained in the above two battery cell groups when the same current flows therethrough.

Accordingly, the impedance adjusting unit 35 performs impedance matching between the first battery cell group 10-1 and the second battery cell group 10-2. That is, the impedance adjusting unit 35 adjusts the impedance of the first battery cell group 10-1 and the second battery cell group 10-2 such that the total impedance of the first battery cell group 10-1 and the total impedance of the second battery cell group 10-2 are the same. For example, since the inner impedance of the first battery cell group 10-1 is greater than the inner impedance of the second battery cell group 10-2, the impedance adjusting unit 35 reduces the impedance of the first impedance unit 20-1 and increases the impedance of the second impedance unit 20-2. After such or similar adjustments, a sum of the inner impedance of the first battery cell group 10-1 and the impedance of the first impedance unit 20-1 becomes equal to a sum of the inner impedance of the second battery cell group 10-2 and impedance of the second impedance unit 20-2.

However, the method of adjusting the impedance described above is not limited thereto. That is, the impedance of the first impedance unit 20-1 is not necessarily the least. In other words, impedances of the first impedance unit 20-1 and the second impedance unit 20-2 may be adjusted as desired so as to satisfy a desired condition, such as: Inner impedance of the first battery cell group 10-1−inner impedance of the second battery cell group 10-2=impedance of the second impedance unit 20-2−impedance of the first impedance unit 20-1.

If the charging state of the first battery cell group 10-1 is greater than a reference value, the impedance adjusting unit 35 may determine that the present state is a high capacity state. In a high capacity state, a voltage of the first battery cell group 10-1 approaches a charging limit voltage. As charging is conducted and a voltage of the first battery cell group 10-1 reaches the charging limit voltage, charging is completed. However, the second battery cell group 10-2 has a lower degree of deviation than that of the first battery cell group 10-1, and thus, a relatively high chargeable capacity remains in the second battery cell group 10-2. Accordingly, in a high capacity state, a charging current flowing to the second battery cell group 10-2 may preferably be greater than a charging current flowing to the first battery cell group 10-1.

Accordingly, the impedance adjusting unit 35 adjusts the impedance of the first impedance unit 20-1 and the second impedance unit 20-2 such that the total impedance of the first battery cell group 10-1 is greater than the total impedance of the second battery cell group 10-2. For example, the impedance adjusting unit 35 reduces the impedance of the second impedance unit 20-2, and increases the impedance of the first impedance unit 20-1. Accordingly, a sum of the inner impedance of the first battery cell group 10-1 and the impedance of the first impedance unit 20-1 is greater than a sum of the inner impedance of the second battery cell group 10-2 and the impedance of the second impedance unit 20-2, and accordingly, when a charging current flowing through a high current path is distributed, an amount of a charging current flowing to the first battery cell group 10-1 is greater than an amount of a charging current flowing to the second battery cell group 10-2. Impedances of the first impedance unit 20-1 and the second impedance unit 20-2 may be determined by a difference in degrees of deviation of the first battery cell group 10-1 and the second battery cell group 10-2.

By adjusting the impedance as described above, the first battery cell group 10-1 and the second battery cell group 10-2 may reach a full charging state at the same time.

Next, a discharging state of the battery pack 1 is described. In a discharging state, the comparator 34 compares a charging state of the first battery cell group 10-1 with a reference value. If the charging state of the first battery cell group 10-1 is greater than the reference value, the impedance adjusting unit 35 determines that a current state is as a high capacity state. In a high capacity state, the same current may preferably flow to the first battery cell group 10-1 and the second battery cell group 10-2. The reason is that the same discharging amount per unit time may be maintained in the above two battery cell groups when the same current flows therethrough.

Accordingly, the impedance adjusting unit 35 performs impedance matching between the first battery cell group 10-1 and the second battery cell group 10-2. That is, the impedance adjusting unit 35 adjusts the impedance of the first impedance unit 20-1 and the second impedance unit 20-2 such that the total impedance of the first battery cell group 10-1 and the total impedance of the second battery cell group 10-2 are the same. For example, since the inner impedance of the first battery cell group 10-1 is greater than the inner impedance of the second battery cell group 10-2, the impedance adjusting unit 35 reduces the impedance of the first impedance unit 20-1, and increases the impedance of the second impedance unit 20-2. Accordingly, a sum of the inner impedance of the first battery cell group 10-1 and the impedance of the first impedance unit 20-1 becomes equal to a sum of the inner impedance of the second battery cell group 10-2 and the impedance of the second impedance unit 20-2.

However, the method of adjusting the impedance described above is not limited thereto. That is, the impedance of the first impedance unit 20-1 is not necessarily the least. In other words, impedances of the first impedance unit 20-1 and the second impedance unit 20-2 may be adjusted as desired so as to satisfy a condition, such as: Inner impedance of the first battery cell group 10-1−inner impedance of the second battery cell group 10-2−impedance of the second impedance unit 20-2−impedance of the first impedance unit 20-1.

If a charging state of the first battery cell group 10-1 is less than a reference value, the impedance adjusting unit 35 determines that the present state is a low capacity state. In a low capacity state, a voltage of the first battery cell group 10-1 approaches a discharging limit voltage. As discharging is conducted and a voltage of the first battery cell group 10-1 reaches the discharging limit voltage, discharging is completed. However, the second battery cell group 10-2 has a lower degree of deviation than that of the first battery cell group 10-1, and thus, a dischargeable capacity remains in the second battery cell group 10-2. Accordingly, in a low capacity state, a discharging current flowing out of the second battery cell group 10-2 may preferably be greater than a discharging current flowing out of the first battery cell group 10-1.

Accordingly, the impedance adjusting unit 35 adjusts the impedance of the first impedance unit 20-1 and the second impedance unit 20-2 such that the total impedance of the first battery cell group 10-1 is greater than the total impedance of the second battery cell group 10-2. For example, the impedance adjusting unit 35 reduces the impedance of the second impedance unit 20-2, and increases the impedance of the first impedance unit 20-1. Accordingly, a sum of the inner impedance of the first battery cell group 10-1 and the impedance of the first impedance unit 20-1 is greater than a sum of the inner impedance of the second battery cell group 10-2 and the impedance of the second impedance unit 20-2, and accordingly, an amount of a discharging current flowing from the second battery cell group 10-2 is greater than an amount of a discharging current flowing from the first battery cell group 10-1. Impedances of the first impedance unit 20-1 and the second impedance unit 20-2 may be determined by a difference in deviation of the first battery cell group 10-1 and the second battery cell group 10-2.

Although the same reference values are described for charging and discharging in the current embodiment, other embodiments are not limited thereto. For example, when conducting charging, impedances of the first impedance unit 20-1 and the second impedance unit 20-2 are adjusted with respect to whether a charging state of a battery cell group having a high degree of deviation exceeds 70%. Also, when conducting discharging, impedances of the first impedance unit 20-1 and the second impedance unit 20-2 may be adjusted with respect to whether a charging state of a battery cell group having a high degree of deviation is less than 30%. That is, reference values may be set differently for charging and discharging.

The battery protection circuit 40 is provided between the positive electrode terminal 50 and the negative electrode terminal 51 connected to the first battery cell group 10-1 and the second battery cell group 10-2 and a charger to control flow of charging and discharging currents. The battery protection circuit 40 may include a passive device operating according to a control of the battery management unit 30 and a self-operating active device. For example, the battery protection circuit 40 may include a charging control switch and a discharging control switch that are turned on or off according to a control of the battery management unit 30 to allow a flow of a charging current or a discharging current or to block a flow of a charging current or a discharging current. Also, the battery protection circuit 40 may include a fuse opening a charging/discharging path that permanently blocks a flow of a current when an overcurrent flows through the charging/discharging path.

The positive electrode terminal 50 and the negative electrode terminal 51 may be, for example, connected to an external electronic device such as a mobile phone or a laptop computer. When the positive electrode terminal 50 and the negative electrode terminal 51 are connected to a charger, a charging current flows to the positive electrode terminal 50 and a charging current flows out of the negative electrode terminal 51. In contrast, when the positive electrode terminal 50 and the negative electrode terminal 51 are connected to an external electronic device, a discharging current flows out of the positive electrode terminal 50 and a discharging current flows to the negative electrode terminal 51.

Although the positive electrode terminal 50 and the negative electrode terminal 51 are illustrated as being connected to a charger and an external electronic device in the current embodiment of the present invention, the embodiments of the present invention are not limited thereto. For example, a charging terminal and a discharging terminal may be separately included, and the charging terminal may be connected to a charger and the discharging terminal may be connected to an external electronic device.

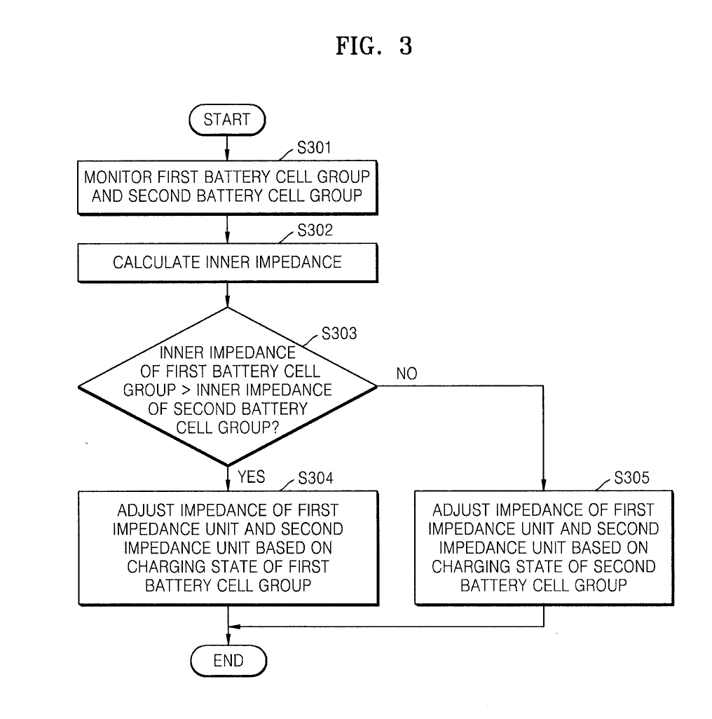

FIG. 3 is a flowchart illustrating a method of controlling the battery pack 1 according to an embodiment of the present invention.

Referring to FIG. 3, the monitoring unit 31 monitors the first battery cell group 10-1 and the second battery cell group 10-2 in operation S301. For example, the monitoring unit 31 may monitor a voltage and temperature of the first battery cell group 10-1 and the second battery cell group 10-2 and a magnitude of a current flowing through the first battery cell group 10-1 and the second battery cell group 10-2.

The impedance calculation unit 32 receives a monitoring result of the monitoring unit 31 and calculates an inner impedance of the first battery cell group 10-1 and the second battery cell group 10-2 in operation S302. That is, a degree of deviation of the first battery cell group 10-1 and the second battery cell group 10-2 is calculated.

The comparator 34 determines whether the inner impedance of the first battery cell group 10-1 is greater than the inner impedance of the second battery cell group 10-2 based on a calculation result of the impedance calculation unit 32 in operation S303.

In operation S304, the impedance adjusting unit 35 adjusts impedances of the first impedance unit 20-1 and the second impedance unit 20-2 based on a charging state of the first battery cell group 10-1 if the inner impedance of the first battery cell group 10-1 is greater than the inner impedance of the second battery cell group 10-2. To adjust the impedance, the charging state calculation unit 33 may use a monitoring result of the monitoring unit 31 to calculate charging states of the first battery cell group 10-1 and the second battery cell group 10-2.

In operation S305, the impedance adjusting unit 35 adjusts impedances of the first impedance unit 20-1 and the second impedance unit 20-2 based on a charging state of the second battery cell group 10-2 if inner impedance of the first battery cell group 10-1 is equal to or less than the inner impedance of the second battery cell group 10-2.

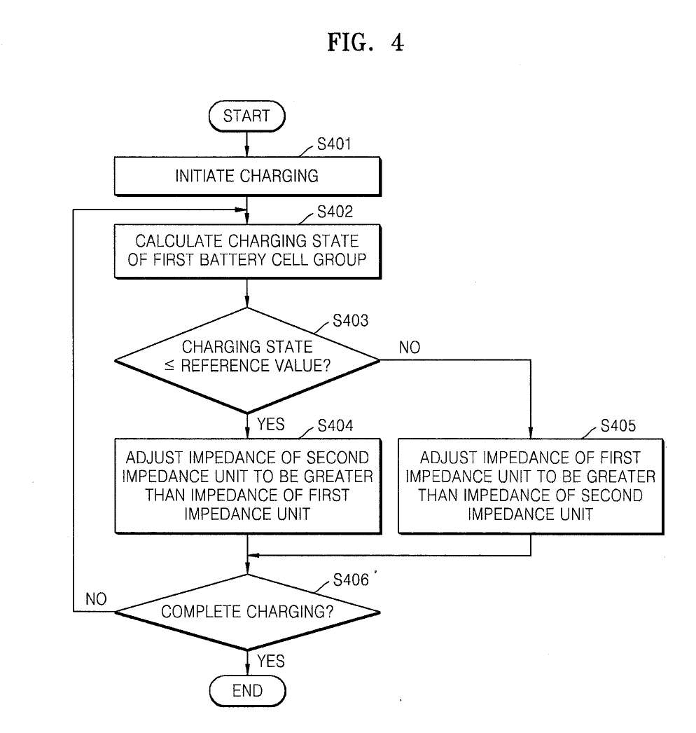

FIG. 4 is a flowchart illustrating a method of controlling the battery pack 1 according to another embodiment. In the current embodiment, a degree of deviation of the first battery cell group 10-1 is greater than a degree of deviation of the second battery cell group 10-2.

Referring to FIG. 4, when charging is initiated in operation S401, the charging state calculation unit 33 calculates a charging state of the first battery cell group 10-1 which has a higher degree of deviation then the second battery cell group 10-2, and the charging state calculation unit 33 determines whether the calculated charging state is equal to or less than a reference value in operation S403.

If the calculated charging state of the first battery cell group 10-1 is equal to or less than the reference value, the charging state calculation unit 33 determines that the first battery cell group 10-1 is in a low-capacity state, and that impedance matching is to be conducted between the first battery cell group 10-1 and the second battery cell group 10-2. Accordingly, the impedance adjusting unit 35 adjusts the impedance of the second impedance unit 20-2 to be greater than the impedance of the first impedance unit 20-1 in operation S404.

If the calculated charging state is greater than the reference value, the impedance adjusting unit 35 determines that the first battery cell group 10-1 is in a high-capacity state, and adjusts the impedance of the first impedance unit 20-1 to be greater than the impedance of the second impedance unit 20-2 in operation S405.

In operation S406, the charging state calculation unit 33 determines whether charging is completed, and if charging is not completed, the method returns to operation S402. When charging is determined as completed in operation S406, the charging operation is stopped.

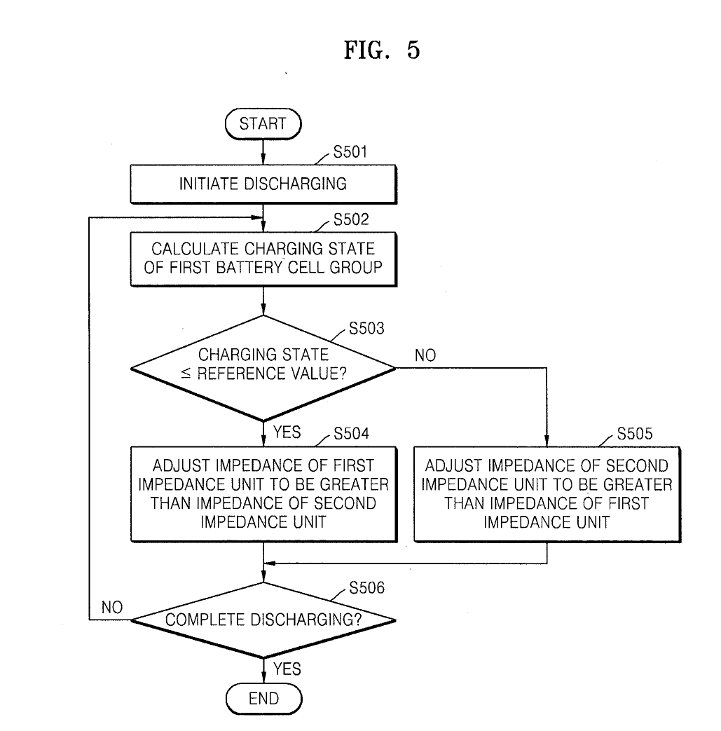

FIG. 5 is a flowchart illustrating a method of controlling a battery pack according to another embodiment. In the current embodiment, a degree of deviation of the first battery cell group 10-1 is greater than that of the second battery cell group 10-2.

Referring to FIG. 5, when discharging is initiated in operation S501, the charging state calculation unit 33 calculates a charging state of the first battery cell group 10-1 which has a higher degree of deviation than the second battery cell group 10-2, and the charging state calculation unit 33 determines whether the calculated charging state is equal to or less than a reference value in operation S503.

If the calculated charging state is greater than the reference value, the charging state calculation unit 33 determines that the first battery cell group 10-1 is in a high-capacity state, and determines that impedance matching is required between the first battery cell group 10-1 and the second battery cell group 10-2. Accordingly, the impedance adjusting unit 35 adjusts the impedance of the second impedance unit 20-2 to be greater than the impedance of the first impedance unit 20-1 in operation S505.

If the calculated charging state is equal to or less than the reference value, the impedance adjusting unit 35 determines that the first battery cell group 10-1 is in a low-capacity state, and adjusts the impedance of the first impedance unit 20-1 to be greater than the impedance of the second impedance unit 20-2 in operation S504.

In operation S506, the impedance adjusting unit 35 determines whether discharging is completed, and if discharging is not completed, the method returns to operation S502. When discharging is determined as being completed in operation S506, the discharging operation is stopped.

The degree of deviation of the battery cells increases as charging or discharging is repeated more times, and an inner impedance such as an inner resistance increases with the degree of deviation. However, the respective degree of deviation of the battery cells is not the same, and a deviation difference occurs. Accordingly, when the first battery cell group 10-1 and the second battery cell group 10-2 are connected in parallel as in FIG. 1 and degrees of deviation of the battery cell groups are different, a charging efficiency and a discharging efficiency of the battery pack 1 may decrease.

For example, if a degree of deviation of the first battery cell group 10-1 is high, even when charging of the second battery cell group 10-2 is not completed, a voltage of the first battery cell group 10-1 may reach a charging limit voltage, and charging of the whole battery pack 1 may be ended. Likewise, when conducting discharging, even when discharging of the second battery cell group 10-2 is not completed, a voltage of the first battery cell group 10-1 may reach a discharging limit voltage, and discharging of the whole battery pack 1 may be ended. That is, the performance of the battery pack 1 may not be as high as possible.

However, as described above, the performance of the battery pack 1 may be improved by adjusting impedances of the first impedance unit 20-1 and the second impedance unit 20-2 according to a degree of deviation and a charging state of the first battery cell group 10-1 and the second battery cell group 10-2.

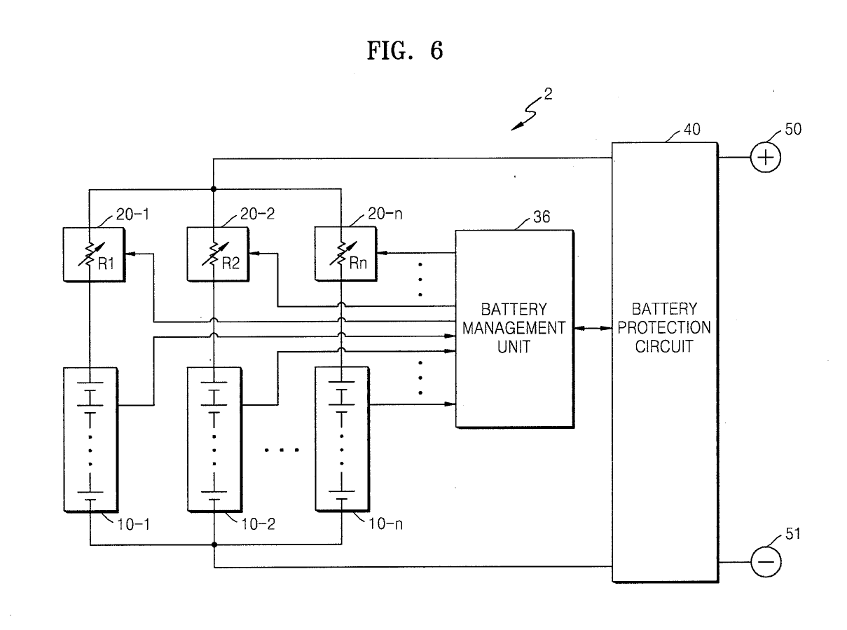

FIG. 6 is a block diagram illustrating a battery pack 2 according to another embodiment. The description will focus on the difference of the battery pack 2 from the battery pack 1.

Referring to FIG. 6, the battery pack 2 includes at least three battery cell groups 10-1 through 10-n and at least three impedance units 20-1 through 20-n that are respectively serially connected to the battery cell groups 10-1 through 10-n. The number of the battery cell groups 10-1 through 10-n and the number of the impedance units 20-1 through 20-n may be the same.

The battery management unit 36 monitors the plurality of battery cell groups 10-1 through 10-n to obtain voltage, current, and temperature data. The battery management unit 36 uses a monitoring result to calculate an inner impedance of the plurality of battery cell groups 10-1 through 10-n, that is, a degree of deviation and a charging state thereof.

Also, the battery management unit 36 adjusts the impedance of the plurality of impedance units 20-1 through 20-n with respect to one battery cell group having the greatest degree of deviation.

The battery management unit 36 according to the current embodiment may be substantially the same as the battery management unit 30 of FIG. 2.

As described above, even when the number of the battery cell groups 10-1 through 10-n exceeds two, best performance of the battery pack 2 may be achieved by adjusting the impedance of the plurality of impedance units 20-1 through 20-n according to a degree of deviation and a charging state of the battery cell groups 10-1 through 10-n.

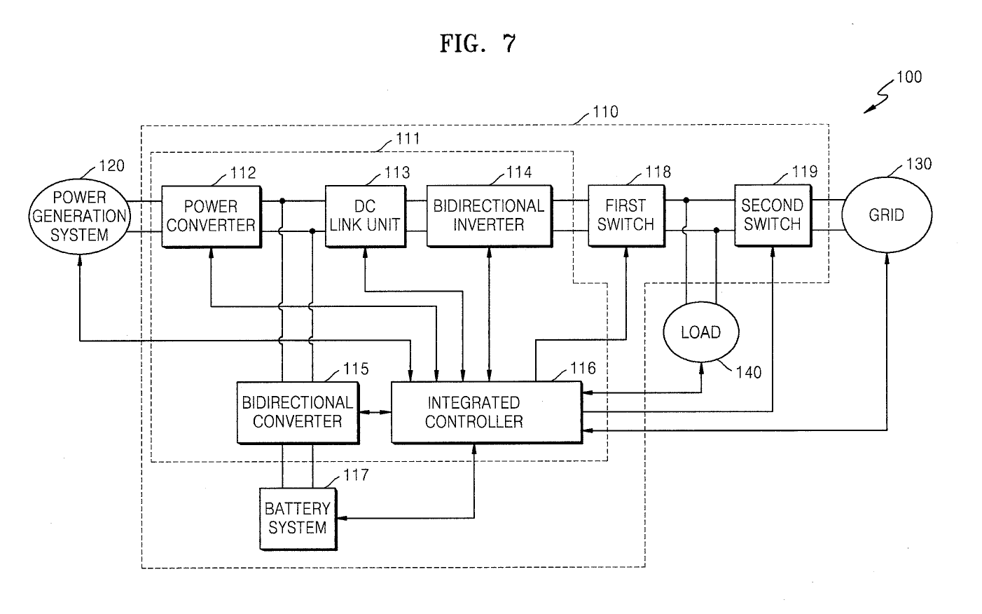

FIG. 7 is a block diagram illustrating an energy storage system 110 including the battery pack 2, according to an embodiment. Referring to FIG. 7, an energy storage system 110 according to the current embodiment supplies power to a load 140 in connection with a power generation system 120 and a grid 130.

The power generation system 120 generates power by using an energy source. The power generation system 120 supplies the generated power to the energy storage system 110. The power generation system 120 may be a photovoltaic power generation system, a wind power generation system, a tidal power generation system, or the like; however, any power generation system for generating power from renewable energy, such as solar heat or geothermal heat, may be used. In particular, a solar cell for generating electric energy from sunlight may be easily installed in a house or a factory, and may be appropriate for the energy storage system 110. The power generation system 120 includes a plurality of power generation modules formed in parallel and generates power from each power generation module, thereby forming a large-capacity energy system.

The grid 130 includes a power plant, a substation, a power cable, etc. When the grid 130 is in a normal state, the grid 130 supplies power to the energy storage system 110 or the load 140 and/or a battery system 117 and receives power supplied from the energy storage system 110. When the grid is in an abnormal state, the grid 130 stops supplying power to the energy storage system 110 or the load 140, and power supplied from the energy storage system 110 to the grid 130 is also stopped.

The load 140 consumes power generated by the power generation system 120, power stored in the battery system 117, or power supplied from the grid 130. The load 140 may be a house or a factory.

The energy storage system 110 may store power generated by the power generation system 120 in the battery system 117 and send the generated power to the grid 130. Also, the energy storage system 110 may send the power stored in the battery system 117 to the grid 130 or store the power supplied from the grid 130 in the battery system 117. When the grid 130 is in an abnormal state, for example, a power failure state, the energy storage system 110 may perform an uninterruptible power supply (UPS) operation so as to supply power to the load 140. Even when the grid 130 is in a normal state, the energy storage system 110 may supply the generated power or the power stored in the battery system 117 to the load 140.

The energy storage system 110 includes a power conversion system (PCS) 111, the battery system 117, a first switch 118, and a second switch 119.

The PCS 111 converts power of the power generation system 120, the grid 130, and the battery system 117 and supplies the converted to power to where needed. The PCS 111 includes a power converter 112, a direct current (DC) link unit 113, an inverter 114, a converter 115, and an integrated controller 116.

The power converter 112 is connected between the power generation system 120 and the DC link unit 113. The power converter 112 transmits power generated by the power generation system 120 to the DC link unit 113, and more specifically, a voltage output from the power generation system 120 is converted into a DC link voltage.

The power converter 112 may consist of a power conversion circuit such as a converter or a rectification circuit according to the type of the power generation system 120. That is, when the power generation system 120 generates DC power, the power converter 112 may convert DC power into DC power. On the contrary, when power generation system 120 generates AC power, the power converter 112 may operate as a rectification circuit for converting AC power into DC power. In particular, when the power generation system 120 generates power from sunlight, the power converter 112 may include a maximum power point tracking (MPPT) converter that performs MPPT control in order to maximize the amount of power generated by the power generation system 120 according to changes of the amount of solar radiation, temperature, or the like. The power converter 112 may stop operating to minimize power consumed in, for example, the converter, when the power generation system 120 does not generate power.

A magnitude of a DC link voltage may be at an unstable voltage level due to an instantaneous voltage drop of the power generation system 120 or the grid 130, or due to a peak load generated in the load 140. However, the DC link voltage is required to be stable for normal operations of the converter 115 and the inverter 114. The DC link unit 113 may be connected between the power converter 112 and the inverter 114 to maintain a uniform DC link voltage. For example, the DC link unit 113 may be large-capacity capacitor.

The inverter 114 is a power converter connected between the DC link unit 113 and the first switch 118. The inverter 114 converts a DC link voltage that is output from the power generation system 120 and/or the battery system 117 into an AC voltage for the grid 130, and outputs the AC voltage. Also, the inverter 114 may include a rectification circuit that rectifies the AC voltage of the grid 130, converts the AC voltage into a DC link voltage, and outputs the DC link voltage, in order to store power from the grid 130 in the battery system 117.

The inverter 114 may be a bidirectional inverter whose input and output directions may be changed. Alternatively, the inverter 114 may include a plurality of inverters so as to change input and output directions.

The inverter 114 may include a filter for removing a harmonic distortion from the AC voltage that is output from the grid 130. The inverter 114 may also include a phase locked loop (PLL) circuit for synchronizing a phase of the AC voltage that is output from the inverter 114 and a phase of the AC voltage of the grid 130, in order to prevent reactive power loss. In addition, the inverter 114 may perform functions, such as, limiting a voltage range from changing, improving a power factor, eliminating DC components, protecting against transient phenomena, etc. When not in use, the inverter 114 may stop operating in order to minimize power consumption.

The converter 115 is connected between the DC link unit 113 and the battery system 117. The converter 115 may conduct DC-DC conversion of power stored in the battery system 117 in a discharging mode so as to convert the power into a voltage having a level required by the inverter 114, that is, into a DC link voltage. Also, the converter 115 may conduct DC-DC conversion of power output from the power converter 112 in a charging mode or power output from the inverter 114 so as to convert a voltage of the power into a voltage having a level required by the battery system 117, that is, into a charging voltage. When charging or discharging of the battery system 117 is not required, the converter 115 may stop operating to minimize power consumption.

The converter 115 may be a bidirectional converter whose input and output directions may be changed. Alternatively, the converter 115 may include a plurality of inverters so as to change input and output directions.

The integrated controller 116 monitors states of the power generation system 120, the grid 130, the battery system 117, and the load 140, and controls the power converter 112, the inverter 114, the converter 115, the battery system 117, the first switch 118, and the second switch 119 according to a result of the monitoring. The integrated controller 116 monitors whether a power failure has occurred in the grid 130, whether the power generation system 120 generates power, and if the power generation system 120 generates power, the integrated controller 116 monitors an amount of the power, a charging state of the battery system 117, an amount and time of power consumption of the load 140, etc. Also, the integrated controller 116 may set priorities of devices that are included in the load 140 and use power in the case when power to be supplied to the load 140 is not sufficient, for example, when a power failure has occurred in the grid 130. The integrated controller 116 may control the load 140 such that power is supplied to a device having a higher priority.

The first switch 118 and the second switch 119 are connected in series between the inverter 114 and the grid 130, and perform on/off operations under the control of the integrated controller 116 to control a flow of current between the power generation system 120 and the grid 130. The on/off operations of the first switch 118 and the second switch 119 may be determined according to states of the power generation system 120, the grid 130, and the battery system 117.

In detail, when supplying power of the power generation system 12.0 and/or the battery system 117 to the load 140 or when supplying power of the grid 130 to the battery system 117, the first switched 118 is turned on. When supplying power of the power generation system 120 and/or of the battery system 117 to the grid 130, or when supplying power of the grid 130 to the load 140 and/or the battery system 117, the second switch 119 is turned on.

Meanwhile, when a power failure occurs in the grid 130, the second switch 119 is turned off and the first switch 118 is turned on. That is, the power generated in the power generation system 120 and/or stored in the battery system 117 may be supplied to the load 140, and at the same time, flow of the power supplied to the load 140 to the grid 130 is prevented. Accordingly, a standalone operation of the energy storage system 110 is prevented, thereby preventing accidents, such as, an electric shock caused by the power from the energy storage system 110 when a worker is working on a power line of the grid 130.

As the first switch 118 and the second switch 119, a switching device such as a relay capable of sustaining a large current may be used.

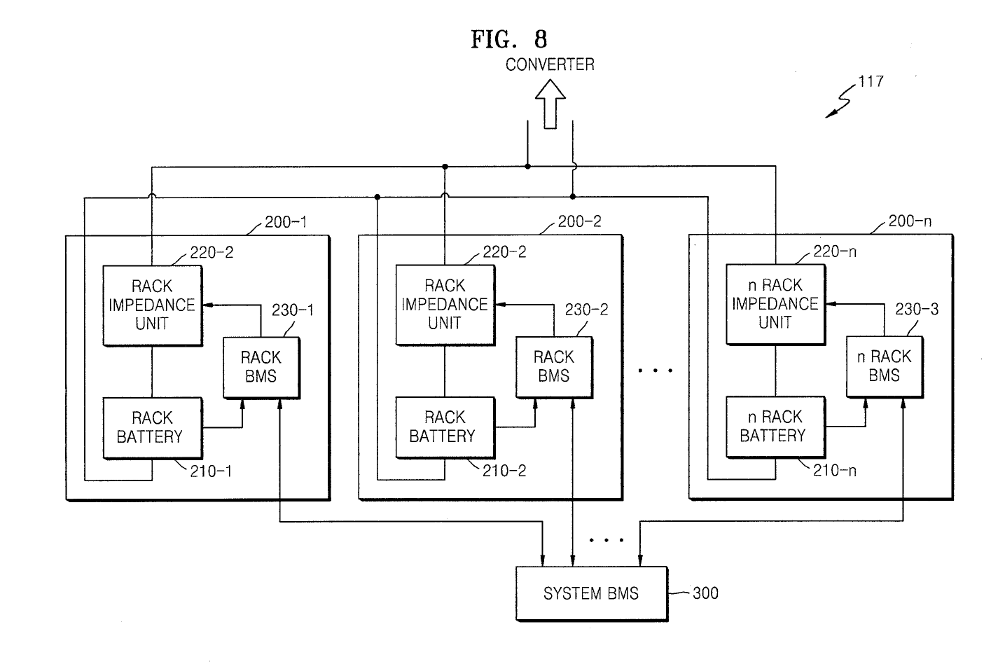

The battery system 117 receives power from the power generation system 120 and/or the grid 130, and supplies power stored to the load 140 or the grid 130. The battery system 117 may include a unit for storing power and a unit for controlling and protecting the unit for storing power. The battery system 117 may include the battery packs 1 and 2 of FIGS. 1 through 6. Hereinafter, the battery system 117 will be described in detail with reference to FIG. 8.

FIG. 8 is a block diagram illustrating the battery system 117 according to an embodiment.

Referring to FIG. 8, a plurality of battery racks 200-1 through 200-n may be disposed in parallel to supply sufficient power to the load 140. The battery racks 200-1 through 200-n may respectively include rack batteries 210-1 through 210-n, rack impedance units 220-1 through 220-n, and rack battery management systems (BMS) 230-1 through 230-n. The battery system 117 may include a system BMS 300 to control all of the plurality of battery racks 200-1 through 200-n.

The rack batteries 210-1 through 210-n are a unit in which electrical energy is stored, and may respectively correspond to the plurality of battery cell groups 10-1 through 10-n illustrated in FIG. 6.

The rack BMSs 230-1 through 230-n monitor the rack batteries 210-1 through 210-n to obtain voltage, current, and temperature data, and may transmit the same to the system BMS 300. Also, the rack BMSs 230-1 through 230-n may adjust an impedance of the rack impedance units 220-1 through 220-n according to a control of the system BMS 300. That is, the rack BMSs 230-1 through 230-n may correspond to the monitoring unit 31 and the impedance adjusting unit 35 of FIG. 2.

Also, the rack BMSs 230-1 through 230-n may calculate a degree of deviation or a charging state of the rack batteries 210-1 through 210-n based on the obtained voltage, current, and temperature data. Accordingly, the rack BMSs 230-1 through 230-n may also correspond to the impedance calculation unit 32 and the charging state calculation unit 33 of FIG. 2.

Meanwhile, the system BMS 300 may receive a monitoring result, that is, voltage, current, and temperature data from the rack BMSs 230-1 through 230-n, and may calculate a degree of deviation or a charging state of the rack battery 210-1 through 210-n from the received data. In this case, the system BMS 300 may correspond to the impedance calculation unit 32 and the charging state calculation unit 33 of FIG. 2. However, the system BMS 300 is not limited thereto, and the system BMS 300 may also receive data about a degree of deviation and a charging state, which are calculated completely, from the rack BMSs 230-1 through 230-n.

In addition, the system BMS 300 may use the received or calculated degree of deviation and a charging state that are received or calculated to determine the impedance of the rack impedance units 220-1 through 220-n, and may send a control signal to the rack BMSs 230-1 through 230-n so that the rack impedance units 220-1 through 220-n have the determined impedance. That is, the system BMS 300 may correspond to the comparator 34 and the impedance adjusting unit 35 of FIG. 2.

As described above, the battery packs 1 and 2 described with reference to FIGS. 1 through 6 may be applied to the energy storage system 110. Thus, by adjusting the impedance of the rack impedance units 220-1 through 220-n in consideration of deviation in deviation degrees of the battery racks 200-1 through 200-n, the battery system 117 may have the best performance.

The particular implementations shown and described herein are illustrative examples of the invention and are not intended to otherwise limit the scope of the invention. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A battery pack comprising:
a first battery cell group comprising a plurality of battery cells;
a second battery cell group comprising a plurality of battery cells;
a first impedance unit serially connected to the first battery cell group;
a second impedance unit serially connected to the second battery cell group; and
a battery management unit respectively configured to determine a degree of deviation of the first battery cell group and the second battery cell group to adjust impedances of the first impedance unit and the second impedance unit.

2. The battery pack of claim 1, wherein the battery management unit is configured to adjust the impedance of the second impedance unit to be greater than the impedance of the first impedance unit during charging of the battery pack as a result of the degree of deviation of the first battery cell group being greater than the degree of deviation of the second battery cell group and a charging state of the first battery cell group being equal to or less than a reference value.

3. The battery pack of claim 2, wherein the battery management unit is configured to adjust the impedances of the first impedance unit and the second impedance unit such that a sum of an inner impedance of the first battery cell group and the impedance of the first impedance unit is substantially equal to a sum of an inner impedance of the second battery cell group and the impedance of the second impedance unit.

4. The battery pack of claim 1, wherein the battery management unit is configured to adjust the impedance of the first impedance unit to be greater than the impedance of the second impedance unit during charging of the battery pack based on the degree of deviation of the first battery cell group being greater than the degree of deviation of the second battery cell group and a charging state of the first battery cell group being greater than a reference value.

5. The battery pack of claim 4, wherein the battery management unit is configured to adjust the impedances of the first impedance unit and the second impedance unit such that a charging current flowing to the second battery cell group is greater than a charging current flowing to the first battery cell group.

6. The battery pack of claim 4, wherein the battery management unit is configured to adjust the impedances of the first impedance unit and the second impedance unit such that the first battery cell group and the second battery cell group reach a full charging state at the same time.

7. The battery pack of claim 1, wherein the battery management unit is configured to adjust the impedances of the first impedance unit and the second impedance unit such that the impedance of the second impedance unit is greater than the impedance of the first impedance unit during discharging of the battery pack, as a result of the degree of deviation of the first battery cell group being greater than the degree of deviation of the second battery cell group and a charging state of the first battery cell group being equal to or greater than a reference value.

8. The battery pack of claim 7, wherein the battery management unit is configured to adjust the impedances of the first impedance unit and the second impedance unit such that a sum of an inner impedance of the first battery cell group and the impedance of the first impedance unit is substantially equal to a sum of an inner impedance of the second battery cell group and the impedance of the second impedance unit.

9. The battery pack of claim 1, wherein the battery management unit is configured to adjust the impedance of the first impedance unit to be greater than the impedance of the second impedance unit during discharging of the battery pack based on the degree of deviation of the first battery cell group being greater than the degree of deviation of the second battery cell group and a charging state of the first battery cell group being equal to or less than a reference value.

10. The battery pack of claim 9, wherein the battery management unit is configured to adjust the impedances of the first impedance unit and the second impedance unit such that a discharging current flowing out of the second battery cell group is greater than a charging current flowing out of the first battery cell group.

11. The battery pack of claim 9, wherein the battery management unit is configured to adjust the impedances of the first impedance unit and the second impedance unit such that the first battery cell group and the second battery cell group reach a full discharging state at the same time.

12. The battery pack of claim 1, wherein the battery management unit is configured to adjust the impedances of the first impedance unit and the second impedance unit in response to one of the first and second battery cell groups having a large degree of deviation.

13. The battery pack of claim 12, wherein the battery management unit is configured to adjust the impedances of the first impedance unit and the second impedance unit during charging or discharging of the battery pack, as a result of comparing a charging state of a battery cell group having a large degree of deviation with a reference value.

14. The battery pack of claim 1, wherein the first impedance unit and the second impedance unit comprise variable resistors.

15. A method of controlling a battery pack comprising a first battery cell group, a second battery cell group, a first impedance unit that is serially connected to the first battery cell group, a second impedance unit that is serially connected to the second battery cell group, and a battery management unit configured to adjust impedances of the first impedance unit and the second impedance unit,
the method comprising:
(a) respectively determining a degree of deviation of the first battery cell group and the second battery cell group;
(b) determining a charging state of the first battery cell group as a result of the degree of deviation of the first battery cell group being greater than the degree of deviation of the second battery cell;
(c) comparing a charging state of the first battery cell with a reference value; and
(d) adjusting impedances of the first impedance unit and the second impedance unit according to a result of the comparing during charging or discharging of the battery pack.

16. The method of claim 15, wherein during charging, the impedances of the first impedance unit and the second impedance unit are adjusted such that the impedance of the second impedance unit is greater than the impedance of the first impedance unit as a result of a charging state of the first battery cell group being equal to or less than the reference value.

17. The method of claim 15, wherein during charging, the impedances of the first impedance unit and the second impedance unit are adjusted such that the impedance of the first impedance unit is greater than the impedance of the second impedance unit as a result of a charging state of the first battery cell group being greater than the reference value.

18. The method of claim 15, wherein during discharging, the impedances of the first impedance unit and the second impedance unit are adjusted such that the impedance of the second impedance unit is greater than the impedance of the first impedance unit as a result of a charging state of the first battery cell group is greater than the reference value.

19. The method of claim 15, wherein during discharging, the impedances of the first impedance unit and the second impedance unit are adjusted such that the impedance of the first impedance unit is greater than the impedance of the second impedance unit as a result of a charging state of the first battery cell group is equal to or less than the reference value.
